(19) United States
(12) Patent Application Publication
(10) Pub. No.: US 2019/0076856 A1
(43) Pub. Date: Mar. 14, 2019

(54) Air Nozzle for Guiding a Steel Strip at the Exit from a Device for Shearing a Steel Sheet

(71) Applicant: ArcelorMittal, Luxembourg (LU)

(72) Inventors: Sheila DIAZ VAQUERO, Gijon, Asturia (ES); Juan José FERNANDEZ LOPEZ, NAVIA, ASTURIAS (ES)

(21) Appl. No.: 16/067,084

(22) PCT Filed: Dec. 29, 2015
(86) PCT No.: PCT/IB2015/002425

§ 371 Date: Jun. 28, 2018

(51) Int. Cl. B05B 1/20; B05B 1/00

(52) U.S. Cl. CPC B05B 1/20; B23D 31/04; B05B 1/005

(57) ABSTRACT

An air nozzle for guiding a cut steel strip at the exit from a shearing device for a moving steel sheet is provided. The nozzle is made in one piece and extends along a main plane perpendicular to the direction of movement of the steel strip. The air nozzle includes an air inlet channel with a free end connected to a compressed air generator and an opposite end divided at a deflection junction into a first and a second air discharge channel facing each other on either side of the main plane. The free end of the first air discharge channel is located close to the exit and includes a plurality of first air discharge orifices orientated towards the second air discharge channel. The free end of the second air discharge channel includes a plurality of second air discharge orifices orientated either in the opposite direction to the first air discharge channel or parallel to the main plane so none of the first and second air discharge orifices are orientated in the opposite direction to the direction of movement of the steel sheet.

The invention primarily relates to an air nozzle for guiding a steel strip at the exit from a device for shearing a steel sheet.

The invention also relates to a device for guiding a steel strip cut at the exit from a device for shearing moving steel sheet which implements such an air nozzle.

The invention also relates to an additive manufacturing method for making such a nozzle and the associated computer-assisted design file.

### BACKGROUND

With reference to FIG. 1 which shows a shearing line comprising a device according to the prior art, a steel sheet 1, running along a direction of movement F1, is cut to the desired width by a longitudinal cut at its edge. This longitudinal cut results in the formation of a strip of cut steel 3 which falls into a skate 4 which receives this cut steel strip 3. The steel sheet can be coated or not, and the cut can for example be performed at the exit of a tinplate line.

The separation of the cut steel strip 3 from the steel sheet 1 and guidance of the cut steel strip 3 into the skate 4 is achieved using two independent air nozzles 5a, 5b which are arranged above and near the steel sheet 1 and the cut strip 3. The two air nozzles 5a, 5b blow out compressed air at a pressure of between 1 MPa and 4 MPa and to this end are each connected to compressed air generators not shown in this figure. The nozzles 5a, 5b are rectilinear and have an identical configuration.

The first nozzle 5a is located near the exit 6 from the shearing device 2 and blows compressed air along a direction F2 directed towards the exit 6 of the shearing device 2 and in the opposite direction to the movement F1 of the steel sheet 1.

The second nozzle 5b, which is located further from the exit 6 from the shearing device 2 and above the skate 4, blows compressed air in a direction F3 directed towards the skate 4 and in the same direction as the movement F1 of the steel sheet 1.

This configuration therefore simultaneously allows the cut steel strip 3 to be separated from the steel sheet 1 at the exit 6 from the shearing device 2 through the action of the first air-nozzle 5a and allows the cut steel strip 3 to be guided into the skate 4 through the action of the second air nozzle 5b.

The orientation of the first air nozzle 5a in a direction which is opposite to the direction of movement of the steel strip 1 may, however, cause slowing of the movement of the cut steel strip 3 or even cause it to be immobilised at the exit 6 from the shearing device 2. This may cause the steel strip 3 to wind onto itself or cause the cut steel strip 3 to overlap the steel sheet 1.

The first nozzle 5a cannot be arranged otherwise due to the dimensions of the shearing device 2 and the need to blow air as close as possible to the exit 6 from this device 2.

### BRIEF SUMMARY

The invention therefore applies principally to an air nozzle which overcomes the aforementioned drawbacks.

An air nozzle of the present invention is provided for guiding a cut steel strip at the exit from a device for shearing a moving steel sheet is made in one piece extending along a main plane intended to be orientated perpendicularly to the direction of movement of the steel sheet, which air nozzle comprises an air inlet channel whose free end is intended to be connected to a compressed air generator and whose opposite end divides at a deflection junction into a first and a second air discharge channel facing each other on either side of the main plane, the free end of the first air discharge channel designed to be located close to the exit from the shearing device comprises a plurality of first air discharge orifices orientated towards the second air discharge channel and the free end of the second air discharge channel comprises a plurality of second air discharge orifices orientated either in the opposite direction to the first air discharge channel or parallel to the main plane such that none of the first and second air discharge orifices are orientated in the opposite direction to the direction of movement of the steel sheet.

The air nozzle of the invention may also comprise the following optional characteristics considered in isolation or according to all possible technical combinations:
the lower part of the second channel exhibits a radius of curvature suitable for an orientation of the second air discharge orifices which is parallel to the main plane, and the lower part of the first channel exhibits a radius of curvature which is suitable for an orientation of the first air discharge orifices towards the second channel and which is smaller than the radius of curvature of the lower part of the second channel.
the air inlet channel is curved and the free end of this air inlet channel is orientated perpendicularly to the main plane.
the first and second air discharge orifices are regularly distributed along, respectively, a first and a second air discharge line, both parallel to the main plane.
the first and second air discharge lines define the respective widths of the free discharge ends of the first and second channels, these widths being greater than the respective widths of the first and second channels taken at the deflection junction, and the first and second channels each exhibit a recess over the width associated with which is a radius of curvature configured so that the air nozzle may be positioned as close as possible to the exit from the device for shearing of the steel sheet without the shearing device being in contact with the air nozzle.

The present invention also provides a device for guiding a cut steel strip at the exit from a device for shearing a moving steel sheet which comprises an air nozzle as described above for which the air inlet channel is connected to a compressed air generator and which is arranged close to the exit of the shearing device and above the skate which receives the cut steel strip.

The device of the invention may also comprise the following optional characteristics considered in isolation or according to all possible technical combinations:
the air nozzle is arranged above and close to the moving steel sheet and to the cut steel strip.
the respective projected orientation lines of the first and second air discharge orifices of the air nozzle cut at a point which is located at the skate which receives the cut steel strip.

The present invention also provides an additive manufacturing method for making the air nozzle as described above.

The present invention further provides a computer assisted design file which, when it is loaded onto a three-dimensional printer, comprises the digital information for implementing the method as described above.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 already described is a schematic representation in longitudinal section of a shearing line comprising a device for guiding a cut steel strip at the exit from a device for shearing a moving steel sheet which implements two compressed air nozzles of the prior art,

FIG. 2 is the same schematic representation as that of FIG. 1 illustrating a shearing line comprising the device for guiding a cut steel strip at the exit from a device for shearing a moving steel sheet which implements the compressed air nozzle of the invention,

FIG. 3 is a diagrammatic representation in perspective of the device according to the invention,

FIG. 4 is a diagrammatic representation from the front of the device according to the invention,

FIG. 5 is a front perspective diagrammatic representation of the air nozzle of the invention,

FIG. 6 is a diagrammatic representation from the side of the device according to the invention,

FIG. 7 is a rear perspective diagrammatic representation of the nozzle of the invention which reveals the internal air channels,

FIG. 8 is a perspective diagrammatic representation of the lower part of the nozzle of the invention in which the air discharge orifices are located, and which shows the internal air channels located in this lower part.

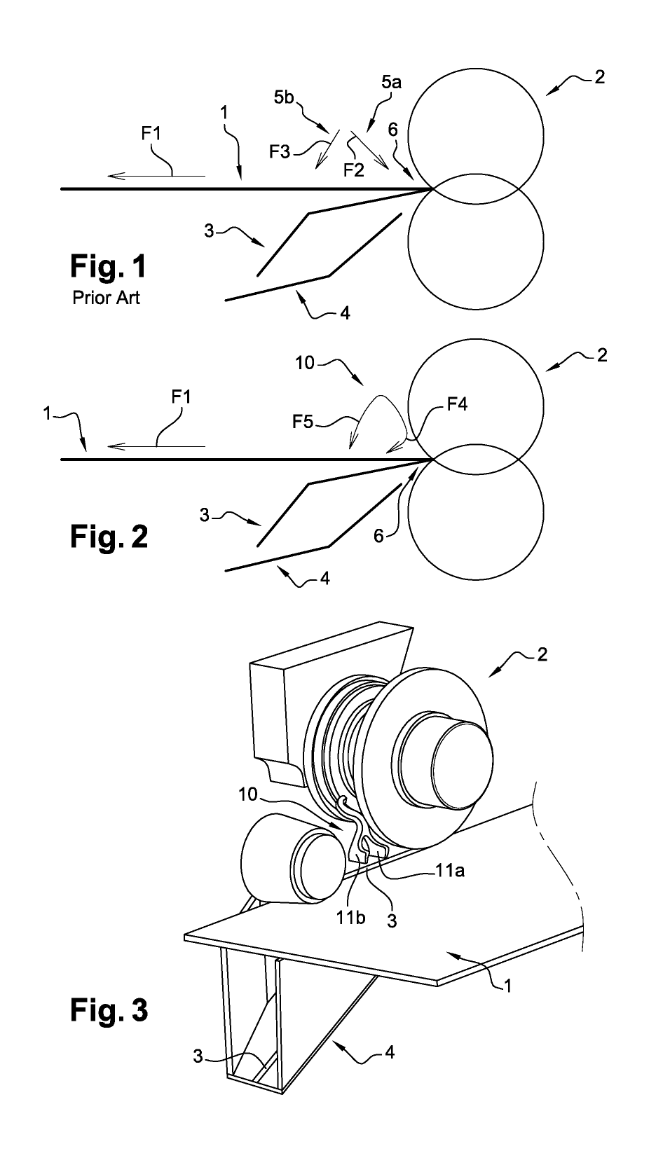

With reference to FIGS. 2 and 3, the air nozzle of the invention 10, a detailed description of which will be given later, replaces the two nozzles of the prior art with references 5a and 5b in FIG. 1. All the other elements of the device for cutting and separating the steel strip 3 are identical, and for this reason the references for the steel sheet 1, the steel strip 3, the shearing device 2 and the skate 4 are unchanged in comparison with those used for the description of the device of the prior art.

As can be seen in these figures, the air nozzle of the invention 10 is made in one piece, is arranged above and close to the steel sheet 1 and the cut strip 3 and in particular comprises a first air discharge channel 11a located close to the exit 6 from the shearing device 2 and a second air discharge channel 11b located further away from the exit 6 from the shearing device 2. The pressure of the compressed air blown out is, as in the prior art, between 1 MPa and 4 MPa.

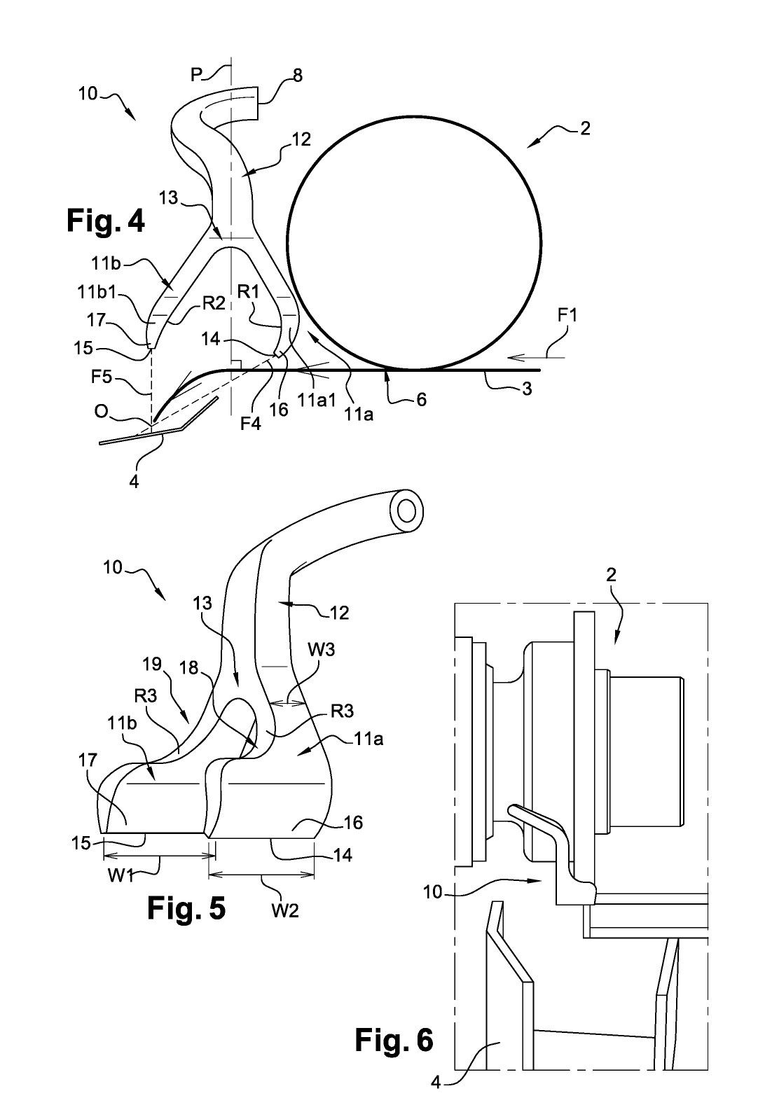

Using means which will be described later, the first discharge channel 11a blows compressed air along a direction F4 directed in the direction of movement F1 of the steel sheet 1 and of the cut strip 3. As for the second discharge channel 11b, this blows compressed air along a direction F5 which approximately corresponds to the direction of discharge F3 from the second nozzle 5b of the prior art. This direction F5 may, in the alternative shown in FIG. 4, be perpendicular to the direction of movement F1 of the steel sheet 1. In any event, the two directions F4 and F5 of discharge of the compressed air are not in the opposite direction to the direction of movement F1 of the steel sheet 1.

With reference to FIG. 4, the nozzle of the invention 10 extends along a main plane P which is perpendicular to the direction of motion F1 of the steel sheet 1. The nozzle of the invention 10 exhibits a downwards orientated overall Y-shape comprising an air inlet channel 12 which divides at a deflection junction 13 into a first air discharge channel 11a located close to the exit 6 from the shearing device 2 and into a second air discharge channel 11b facing the first air discharge channel 11a on either side of the main plane P.

The air inlet channel 12 is curved into an overall S-shape and its free end 8 is therefore oriented perpendicular to the main plane P in order to be connected to a compressed air generator that is not shown. The shape of the air inlet channel 12 is established and may vary according to the configuration of the cutting device on which the nozzle of the invention 10 is located.

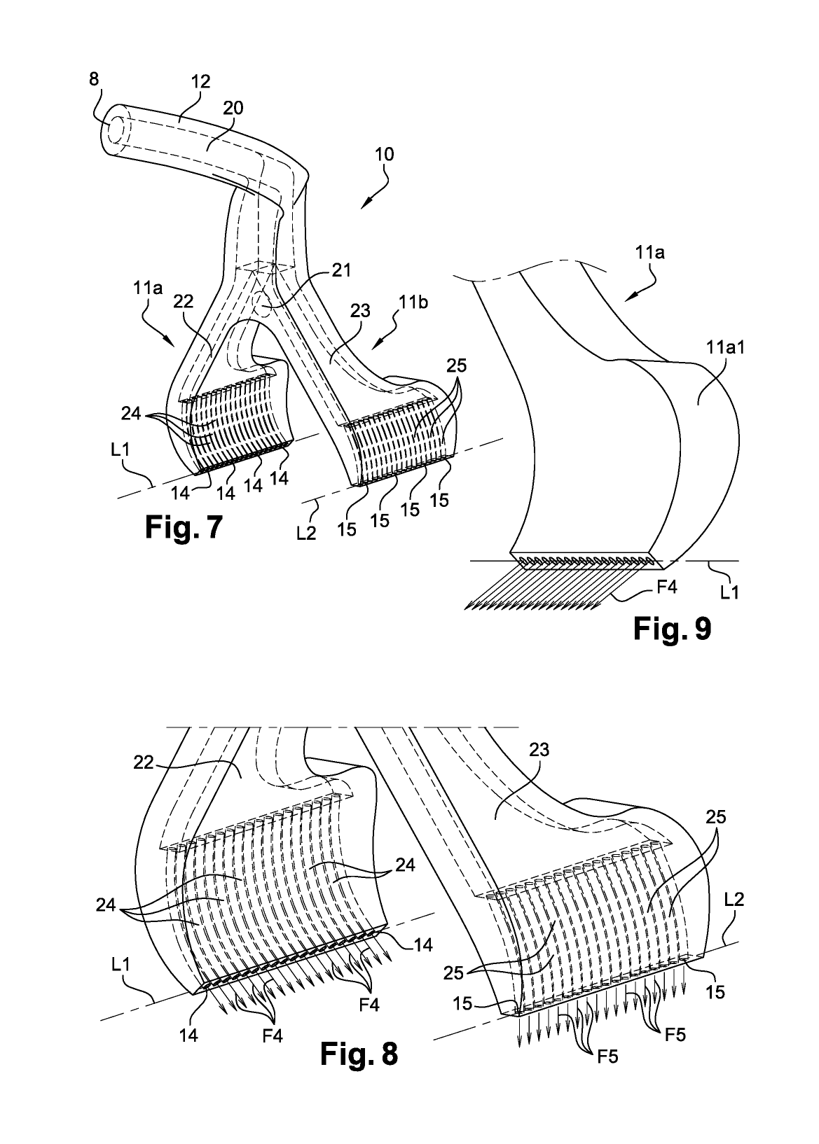

The lower part 11a1 of the first air discharge channel 11a ends in a plurality of first air discharge orifices, which will be better described with reference to FIGS. 7 to 9 and which are orientated along the discharge direction F4 of this first channel 11a. To achieve this the lower part 11a1 exhibits a radius of curvature R1 which results in a controlled curve of the first discharge channel 11a, allowing it to be both as close as possible to the exit 6 from the shearing device 2 and to blow compressed air along direction F4 in the same direction as the direction of movement F1 of the steel sheet 1 and of the cut steel strip 3.

The lower part 11b1 of the second air discharge channel 11b ends in a plurality of second air discharge orifices 15, which will be better described with reference to FIGS. 7 to 9 and which are orientated along the discharge direction F5 of this second channel 11a. To achieve this the lower part 11b1 exhibits a radius of curvature R2 which results in a controlled curvature of the second air channel 11a allowing it to blow compressed air along the direction F5, either in the direction of movement F1 or the steel strip 3 (as shown in FIG. 2), or parallel to the main plane P shown in FIG. 4. The radius of curvature R1 of the first air discharge channel 11a is less than the radius of curvature R2 of the second air discharge channel 11b.

Advantageously the orientation projections of the first 14 and second 15 air discharge orifices or in other words the projections of the respective air discharge direction F4, F5 of the first 11a and second 11b air discharge channels cut each other at a point O located at the skate 4 which receives the cut steel strip 3. This configuration allows the best possible guidance of the steel strip 3 into the bottom of the skate 4.

With reference to FIG. 5, the first 14 and second 15 air discharge orifices of the first 11a and second 11b air discharge channels define the respective widths W1, W2, which are identical here but which may be adapted according to the configuration of the device, of the free discharge ends 16, 17 of the first 11a and second 11b channels.

The first 11a and second 11b air discharge channels each exhibit, over their width, a recess 18, 19 with which a radius of curvature R3 is associated which reduces the width W3 of the first 11a and second 11b air discharge channels at the deflection junction 13.

As can be seen in FIG. 6 this recess allows the nozzle of the invention to be arranged as close as possible to the shearing device 2 without there being interference between the nozzle 10 and the shearing device 2.

With reference to FIGS. 7 to 9 the nozzle of the invention 10 comprises internal channels which allow compressed air to be led from the free end 8 of the air inlet channel 12 to the air discharge orifices 14, 15 each of which are regularly distributed along a respective air discharge line L1, L2 both parallel to the main plane P.

To achieve this the nozzle of the invention 10 comprises a first internal channel 20 which leads compressed air from the free end 8 of the air inlet channel 12 to a deflector 21, where the first internal channel then splits into a first 22 and a second 23 internal channels respectively located within the thickness of the first 11a and second 11b air discharge channels and which terminate in a plurality of discharge channels 24, 25 ending in the respective air discharge orifices 14, 15.

The nozzle of the invention 10 should be applied to a tinplate line, but also to any steel sheet production line that requires the use of compressed air nozzles at the exit of a shearing device.

The nozzle of the invention is made of metal using a three-dimensional printing method. The term three-dimensional printing method relates to an additive method of manufacture in three dimensions.

Thus a computer-assisted design file is made which, when loaded into a three-dimensional printer, comprises digital information which allows a three-dimensional print-out of the nozzle of the invention as described above to be made.

1-9. (canceled)

10. An air nozzle for guiding a cut steel strip at an exit from a shearing device for a moving steel sheet comprising:
an air inlet channel with a free end for connecting to a compressed air generator and an opposite end dividing at a deflection junction into a first and a second air discharge channel facing each other on either side of a main plane;
a free end of the first air discharge channel being located close to an exit from the shearing device, the free end of the first air discharge channel including a plurality of first air discharge orifices orientated towards the second air discharge channel; and
a free end of the second air discharge channel including a plurality of second air discharge orifices orientated either in a direction opposite to the first air discharge channel or parallel to the main plane such that none of the first and second air discharge orifices are orientated in a direction opposite to a direction of movement of the steel sheet;
the nozzle being made in one piece and extending along a main plane perpendicular to the direction of movement of the steel sheet.

11. The air nozzle according to claim 10, wherein a lower part of the second air discharge channel exhibits a radius of curvature (R2) suitable for an orientation of the second air discharge orifices which is parallel to the main plane, and a lower part of the first air discharge channel exhibits a radius of curvature (R1) suitable for an orientation of the first air discharge orifices towards the second channel and which is smaller than the radius of curvature (R2) of the lower part of the second channel.

12. The air nozzle according to claim 10, wherein the air inlet channel is curved and the free end of the air inlet channel is perpendicular to the main plane.

13. The air nozzle according to claim 10, wherein the first and second air discharge orifices are regularly distributed along, respectively, a first and a second air discharge line, both parallel to the main plane.

14. The air nozzle according to claim 13, wherein the first (L1) and second (L2) air discharge lines define the respective widths (W1, W2) of the free discharge ends of the first and second channels, the widths (W1, W2) being greater than respective widths (W3) of the first and second channels taken at the deflection junction, and the first and second channels each exhibit a recess over the width associated with which is a radius of curvature (R3) configured so that the air nozzle may be positioned as close as possible to the exit from the shearing device without the shearing device being in contact with the air nozzle.

15. A device for guiding a cut steel strip at an exit from a shearing device for a moving steel sheet comprising:
an air nozzle according to claim 10;
a compressed air generator connected to the air inlet channel;
the air nozzle being arranged close to an exit of the shearing device and above a skate which receives the cut steel strip.

16. The device according to claim 15, wherein the air nozzle is arranged above and close to the moving steel sheet and to the cut steel strip.

17. The device according to claim 15, wherein respective projected orientation lines (F4, F5) of the first and second air discharge orifices of the air nozzle cut at a point (O) which is located at the skate which receives the cut steel strip.

18. A computer assisted design file which, when loaded onto a three-dimensional printer, comprises digital information for making a three-dimensional print-out of the air nozzle according to claim 10.

19. Computer readable media, having stored thereon, computer executable instructions for printing a three-dimensional printout of the air nozzle according to claim 10.
